(19) United States
(12) Patent Application Publication
(10) Pub. No.: US 2008/0013705 A1
(43) Pub. Date: Jan. 17, 2008

(54) Web-based and telephony-based automated notification method and system

(75) Inventors: Amy J. Yoffie, Westfield, NJ (US); Jean Steckler, Westfield, NJ (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: iReminder, LLC, Westfield, NJ (US)

(21) Appl. No.: 11/827,414

(22) Filed: Jul. 11, 2007

Related U.S. Application Data
(60) Provisional application No. 60/807,052, filed on Jul. 11, 2006.

(51) Int. Cl. H04M 3/42

(52) U.S. Cl. 379/201.12

(57) ABSTRACT

A method and apparatus for providing notification reminders via a communications system, comprising generating at least one of a web-based or telephone-based interface to an account supported by a server, creating, through the at least one of a web-based or telephone-based interface, notification reminder information comprising a notification reminder, contact information for at least one entity to receive the notification reminder; and a mode of receiving the notification reminder.

### CROSS-REFERENCE TO RELATED APPLICATIONS

This application claims benefit of U.S. provisional patent application Ser. No. 60/807,052, filed Jul. 11, 2006, which is herein incorporated by reference.

### BACKGROUND OF THE INVENTION

1. Field of the Invention

Embodiments of the present invention generally relate to a notification system and method, and more specifically, to a web-based and telephony-based method and system for providing automated notifications to a plurality of mutually-agreed upon contacts.

2. Description of the Related Art

In today's fast-paced world, remembering appointments, events, and special dates can be difficult. A person may have multiple appointments in a single day, including business and personal appointments, along with birthdays, anniversaries and dinners to attend, coupled with bills to pay. It is not difficult for one or more appointments and events to be forgotten to the detriment of the respective person. Such forgetfulness typically is enhanced with age and/or chronic illness, and can be particularly detrimental when an elderly or ill person fails to remember a doctor's appointment, take prescribed medication, refill prescribed medication, comply with medication regimen instructions or complete other medically necessary tasks.

About 1.6 billion prescriptions are written every year in the United States. For some patients who have one prescription, compliance may not be difficult. However, many patients are required to take multiple medications monthly, weekly and daily. Such patients also may be elderly and, thus, may have difficulty remembering which medications to take and when. In the U.S. alone, 50-70% of patients with chronic diseases do not comply with prescribed medications, due to the often complex and long-term regimens required by the medication, which can require significant behavioral modification. It is estimated that 10% of all hospitalizations and 20% of nursing home admissions are due to non-compliant patients. Non-compliance costs employers $100-$300 billion annually, the pharmaceutical sector $30 billion annually and payers $8.2 billion annually. Thus, there is an urgent need for assistance in complying with daily medication regimens, medical appointments and other events in an efficient manner.

### SUMMARY OF THE INVENTION

Embodiments of the present invention are directed to a method and a system for providing notification reminders via a communications system comprising generating at least one of a web-based or telephone-based interface to an account supported by a server, creating, through the at least one of a web-based or telephone-based interface, notification reminder information comprising a notification reminder, contact information for at least one entity to receive the notification reminder; and a mode of receiving the notification reminder.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a system for providing web-based and telephony-based automated notifications, in accordance with an embodiment of the present invention;

FIG. 2 is a method of registering and creating automated notifications using a web-based and telephony-based system, in accordance with an embodiment of the present invention;

FIG. 3 is a method of creating automated notifications using a web-based and telephony-based system, in accordance with another embodiment of the present invention;

FIG. 4 illustrates a user profile generated by a system for providing web-based and telephony-based automated notifications, in accordance with an embodiment of the present invention;

FIG. 5 illustrates a system template for creating a web-based and telephony-based automated notification, in accordance with an embodiment of the present invention;

FIG. 6 is a method for creating a personal network within a system for providing web-based and telephony-based automated notifications, in accordance with an embodiment of the present invention;

FIG. 7 illustrates a personal network list providing web-based and telephony-based automated notifications, in accordance with an embodiment of the present invention;

FIG. 8 is a method for providing automated notifications using a web-based and telephony-based system, in accordance with an embodiment of the present invention;

FIG. 9 illustrates a portion of a notification reminder schedule generated by a system for providing web-based and telephony-based automated notifications, in accordance with an embodiment of the present invention;

FIG. 10 illustrates a method for creating a patient profile in accordance with an embodiment of the present invention;

FIG. 11 illustrates a method for tracking each patient's compliance to the reminders they have received, in accordance with an embodiment of the present invention;

FIG. 12 illustrates a method for reviewing recorded reminder messages in accordance with an embodiment of the present invention.

FIG. 13 illustrates a method for creating and scheduling a phone-based recording of a reminder message. in accordance with an embodiment of the present invention;

FIG. 14 demonstrates a method of tracking system usage and resources used, in accordance with an embodiment of the present invention; and

FIG. 15 illustrates the method for entering medications, in accordance with an embodiment of the present invention.

### DETAILED DESCRIPTION

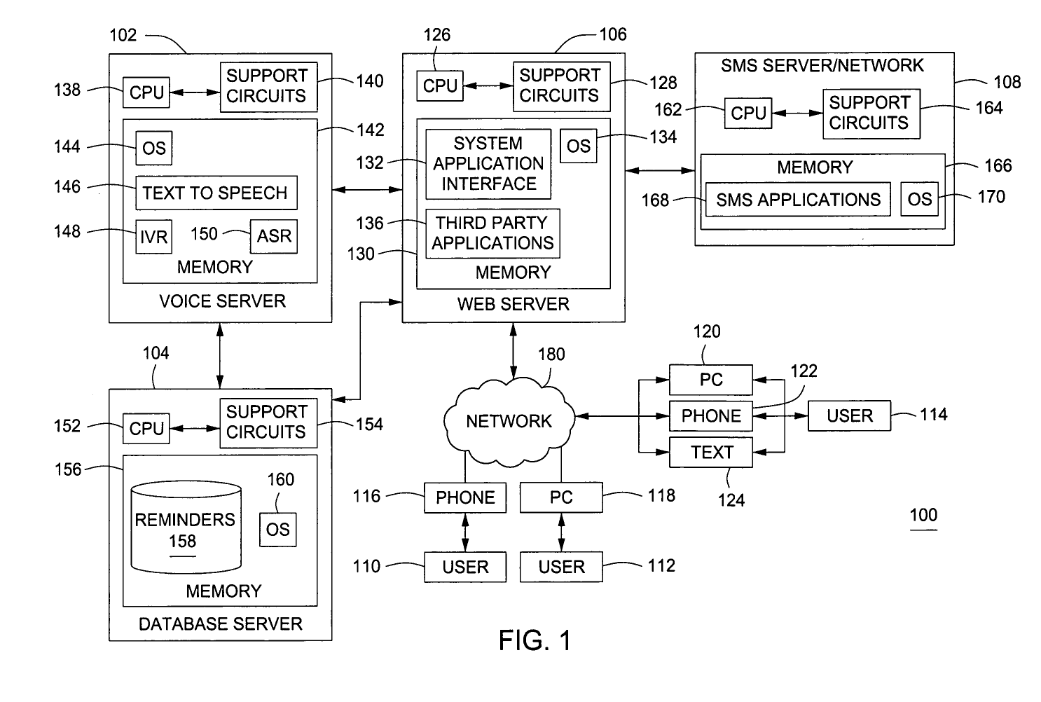

FIG. 1 depicts a block diagram of a web-based and telephony-based system 100 for providing automated notifications. As referred to herein, “notifications” may include, but are not limited to, reminders, such as appointment reminders, medication reminders, and the like, messages, such as gift messages (e.g. “Happy Birthday”), personal messages (e.g. “Somebody loves you”), instructional messages (e.g., “Take medication on an empty stomach” ), and the like, and other types of notifications exchanged for personal or other's use. System 100 includes a voice server 102, a database server 104, a web server 106 and an SMS server (network) 108. Each server 102, 104, 106, and 108 comprises a central processing unit (CPU) 126, 138, 152, 162, support circuits 128, 140, 154, 164 and a memory 130, 142, 156, 166. The CPU 126, 138, 152, 162 may comprise one or more conventionally available microprocessors. The support circuits 128, 140, 154, 164 are well known circuits that comprise power supplies, clocks, input/output interface circuitry, and the like. Although FIG. 1 depicts four servers 106, 102, 104, and 108 in system 100, other embodiments of the present invention include systems with more or less than four cache servers.

Memory 130, 142, 156, 166 may comprise random access memory, read only memory, removable disk memory, flash memory, and various combinations of these types of memory. The memory 130, 142, 156, 166 is sometimes referred to as main memory and may in part be used as cache memory or buffer memory. The memory 130, 142, 156, 166 stores various software packages and components, such as an operating system (O/S) 134, 144, 160, 170.

Preferably, the voice server is an interactive voice server (IVR) with speech recognition. The memory 142 of the voice server may store text-to-speech software 146, IVR software 148, and automated speech recognition (ASR) software 150. The system 100 may use the IVR software 148 to record telephony-key or verbal responses by users to verbal instructions or requests provided by the system 100 over a telephone. ASR software 150 is used to capture verbal responses by users to telephony-based instructions or requests, and the text-to-speech software 146 facilitates converting text notification reminders into verbal messages to be delivered by a telephone.

The memory 156 of the database server 104 includes at least one database 158 for maintaining a plurality of personalized notification reminder schedules. The memory 156 may also store additional databases for user profiles, prescription medication information, voice recordings and other information associated with generating and maintaining the notification schedules. The database server 104 may store the database 158 internally or externally, e.g., on a storage area network.

The web server 106 may be any type of computing device adapted to distribute data and process data requests. The web server 106 executes system application software 132 such as notification reminder software, databases, electronic mail, and the like. The data stored by the system application software 132 is, under normal operation, written to one or more databases, similar to database 158. The memory 130 of the web server 106 includes system application and interfaces 132 for interacting with users, and one or more third party applications 136 utilized in generating the notification reminder schedules.

The system application 132 includes modules for performing functions comprising receiving information, converting the received information to at least one notification file maintained in the database server 104, generating at least one notification reminder schedule associated with the notification file, storing the at least one notification reminder schedule in the database 158, and providing at least one notification reminder to at least one contact associated with the at least one notification reminder schedule. As used herein, the term “file” includes, but is not limited to, application files, text files, audio files, such as .wav files, database entries, and the like.

The database server 104 may store user account/profile data, time and date data, medical data, common social event and anniversary data, personal network lists, pending notification reminders, a history log of notifications generated and received, and the like. Another embodiment of a web-based and telephony-based system for providing automated notifications comprises one database 158 for storing all of the data utilized by the system.

The SMS Server/Network 108 executes SMS applications 168 to facilitate transmitting SMS or “text” messages to users via various telecommunications networks. Using SMS or text messaging enables health related reminders to be sent to mobile users via their cell phones, wireless device, and the like and for them to respond to the request.

A user 110 may interact with the system 100 using a common telephone 116 (PHONE) through a communications network180. Another embodiment includes a user 112 interacting with the system 100 using a personal computer (PC) 118 through a communications network 180. A user 114 also may interact with the system 100 using a PC 120, a common telephone 122, and a text messaging device 124. Additionally, a user 110 may access the system 100 via a phone 116 to enter notification reminder data, and the system 100 receives the data and generates at least a phone call, an email, and/or a text message to be sent to user 114. An instant message associated with instant messaging software, such as America Online Instant Message, also may be generated. The communications network 180 may be any conventional network, such as an Ethernet network, a fiber channel network, a 3G wireless network or a wide area network (WAN) that provides either a direct or indirect (e.g., Internet via a wired or wireless connection, VOIP, or public switched telephone network (PSTN)) connection between the users 110, 112, 114 and the system 100. The network may be, in part, wireless and, in part, wired.

The system 100 presented in FIG. 1 is a stand-alone system. Other embodiments of the present invention include incorporating system 100 into a larger corporate system, such as, for example, part of a medication program offered by a pharmaceutical company or a distributor, a medical insurance company, large employers, disease management firms, managed care organizations, pharmacy benefits managers, integrated health plans, NGOs and associations and/or a pharmacy chain. The system is not limited to a specific operating system, but may be adapted to run on multiple operating systems, such as, for example, Linux and Microsoft Windows.

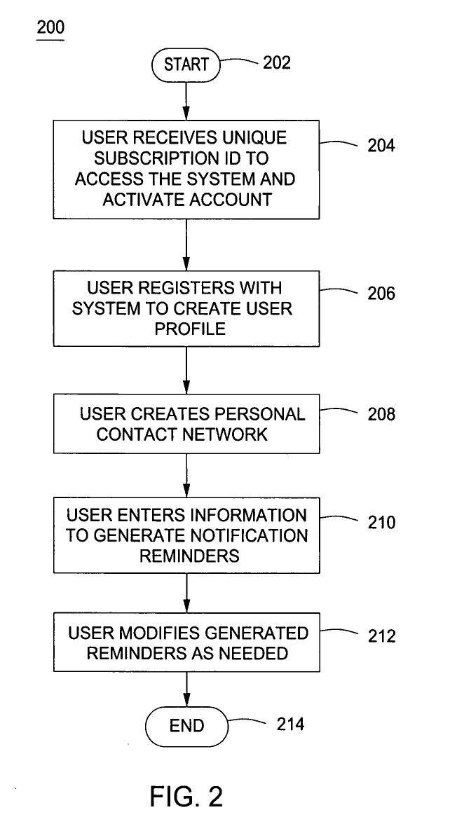

FIG. 2 depicts a flow diagram of an embodiment of a method for registering and creating automated notifications regarding prescribed medication using a web-based and telephony-based system. The steps need not be in the sequence illustrated, and some of the steps may be essentially simultaneous. Although FIGS. 2 through 15 are described with respect to an embodiment for providing notifications regarding medical prescriptions, medication refills, educational messages, and regimen instructions, one of ordinary skill in the art would recognize that the invention may be adapted to generate personal reminders for any type of notification, such as, for example, medical appointments, social events and appointments, business meetings, personal dates, such as anniversaries and birthdays, and the like.

Method 200 begins at step 202 and proceeds to step 204 wherein a user receives a unique subscription identification from an entity maintaining the system, such as a employer, to first access the system and activate an account. The user may activate the account over the phone or online at a proprietary website, or both. For example, the user may activate the account over the phone by responding to a series of questions posed by the system over the phone, or by using a computer to complete a web-based form. For security measures, the user then creates a unique Personal Identification Number (PIN).

Once the account has been activated, the user creates a user profile with the system and provides personal information such as first and last name, email address, relevant phone numbers, a wireless service provider, time zone, secret question and answer, and the like, at step 206. The user also creates a user identification, such as a username or, for the telephony base, a telephone number. The user may access the system using a telephone or via an online connection using a computer.

In step 208, the user may create a personal and/or patient network of alternate contacts, each of whom may opt into the system and agree to receive notification reminders associated with the user's notification reminder schedules. For example, a user may delegate authority to allow one or more network contacts, such as a caregiver or a family member to access the user's account. Each network contact is scheduled to receive an invitation from the system to join, and each network contact performs an activation process. Each time a user, including alternate users, accesses the system, the user identification and unique PIN may be required for authorization. The user may also set up notification reminder schedules for contacts within the user's personal network. Network contacts agree to be included in the user's personal network and agree to receive notifications generated and delivered by the system.

At step 210, the user begins to create a notification reminder schedule using the system. The user may enter any type of information the user wishes to receive notifications about, including, but not limited to, timely prescription medication notifications, medical appointments, business appointments, social events, personal and family events, and the like. For example, the user may enter information related to taking four types of prescribed medication, multiple times within a 24-hour period, for a term of 45 days. The user may enter information related to the delivery modes of notifications or confirmations to be received, such as phone calls, emails, text messages, and the like, and at what times and with what frequency the notifications should occur. Additionally, the user may enter one or more alternative delivery modes and/or back-up contacts from a personal or patient network of the user to receive the notification reminders delivered to the user. The user also may enter one or more confirmation contacts to receive notifications from the system as to whether delivery of a notification reminder to a designated recipient was successful. Thus, the system will attempt to deliver a notification using the selected delivery modes and/or back-up contacts, and once the system has delivered or exhausted these selections, the system then will deliver confirmation notification(s) to the selected confirmation contact(s). For example, a user may be generating a notification to receive reminders to take a plurality of prescribed medications on a daily basis. The user also may select to have a caregiver review the same reminders regarding the prescribed medications to be taken by the user, to facilitate compliance of the user with taking the prescribed medications. In another embodiment, a user of the system may be a caregiver who schedules notification reminders for pre-accepted network contacts, such as, for example, medication notification reminders for recipients under the responsibility of the caregiver.

The user may enter the personalized notification information over the phone using IVR/ASR technology, such as the technology described in U.S. Pat. No. 6,738,740 B1 issued entitled “Speech Recognition System for Interactively Gathering and Storing Verbal Information to Generate Documents.” That is, the user is prompted to speak into the phone to enter necessary data or to depress a phone key in response to a verbal phone command. The system uses ASR technology to convert the spoken information into a .wav or other audio file or text to be incorporated into one or more application files to be used by the system.

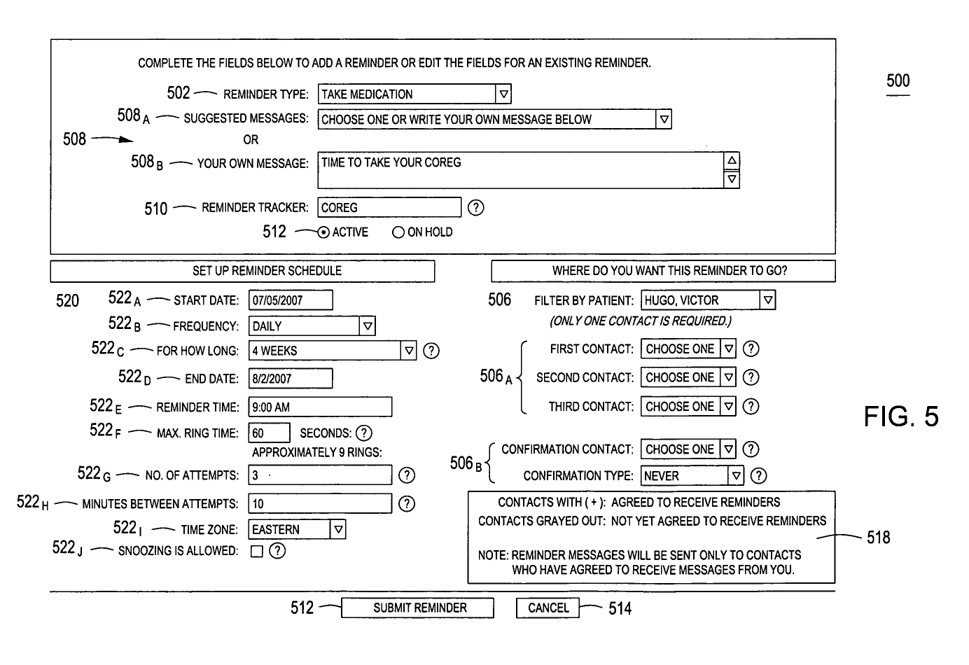

In an alternate embodiment, the user may enter the notification data using a computer by accessing the system online. The system may provide templates for the user to enter notification information, such as the template 500 shown in FIG. 5.

Once the user has completed entering all notification reminder information, the system generates one or more notification reminder schedules accordingly. In step 212, the user may view the notification reminder schedules and may modify the generated schedules as needed. The process 200 ends at step 214.

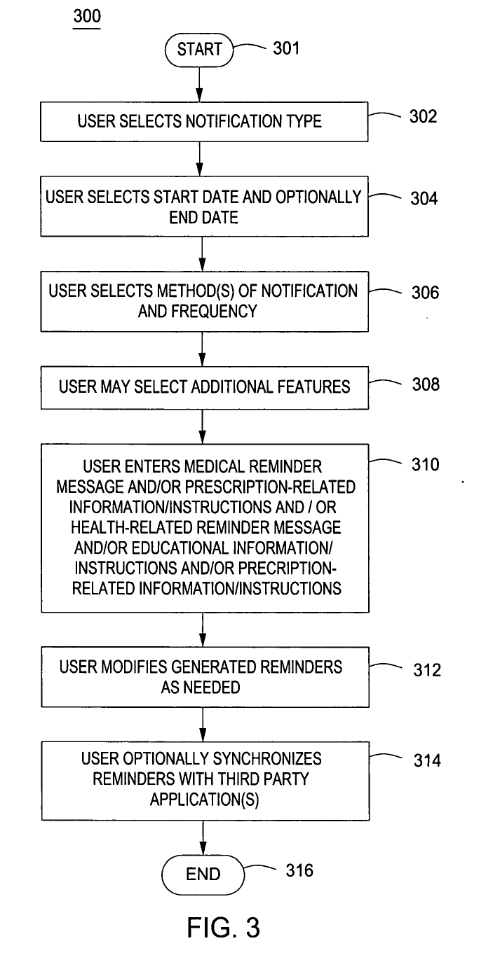

FIG. 3 is a flow diagram of the specific steps that may be performed within step 210 of FIG. 2 to generate one or more notification reminder schedules. The steps need not be in the sequence illustrated, and some of the steps may be essentially simultaneous. In step 302, the user selects the type of notification to be used. Examples of such types include taking medication at a specific time in a day, reoccurring medical appointments, medical refill reminders, physical therapy appointments, and the like. For example, the user may select a notification for taking medication.

In step 304, the user enters a start date and, optionally, an end date for the notification. Alternately, the system may automatically generate an end date based on the notification reminder data entered by the user. In step 306, the user selects one or more delivery modes of notification and the frequency of the notification. For example, if a user is to take a prescribed medicine four times a day, for forty days, the user may enter a start date to take the medication, followed by information related to taking the medication four times within a 24-hour period for a total of forty days. The user may select to receive notification or confirmations via telephone, via email, and via text message. Upon receiving this information, the system then automatically generates a notification reminder schedule to provide notification four times within a 24-hour period, with each notification equally spaced in time from the next and previous notifications, for forty 24-hour periods.

Alternately, the user may create four separate notification reminders, one for each time of day the medication is to be taken. For example, the user may enter a start date and first time of day to receive a reminder and may select for the reminder to repeat 40 times. The user then may enter the same start date and a second time of day to receive a reminder and select for the reminder to repeat 40 times. The process is repeated until the user is satisfied with the notification reminder schedule generated.

The system offers a selection of messages to accompany the notification reminder, such as “Time to take your medication.” The user may modify the message or create a custom message to accompany the notification reminder, such as, for example “Time to take your cholesterol medication.” In another embodiment, the system preselects a message to accompany the notification reminder. In other embodiments where alternate types of notification reminders are generated, examples of notification messages may include, but are not limited to, “Wake up,” “Time to take your heart medication,” “Time to pay bills,” “You have a meeting in half an hour,” or a custom message may be created.

In step 308, the user may customize the notification reminder schedule by selecting and choosing from a plurality of additional system features. Such system features include, but are not limited to, selecting the number of times a phone is to ring before the system registers a failed attempt via that delivery mode; the number of attempts to deliver a notification reminder and the time period between attempts; whether a notification reminder is to be left on an answering machine; the number of failed notification reminder attempts by the system before a back-up contact from the user's personal network is notified; the delivery modes of notification or a confirmation may include, but not limited to, home telephone, cellular telephone, business telephone, email, text message and the like, and the order of delivery for a notification reminder. An optional confirmation feature may be available for each notification reminder, such that if an intended recipient of the reminder does not confirm receipt of the reminder, an automated message may be sent to a network contact designated as a confirmation contact from the user's personal network. Notification reminders also may be sent to a network contact when the intended recipient has confirmed receipt of the notification reminder. For example, a son may receive a phone call that his father has been notified by the system to take certain medications. The son may then be given the opportunity to be connected to his father, via the system, as a further precautionary measure. An additional system feature may include an emergency feature where a recipient of a notification reminder delivered by phone may say “911,” “Help,” and the like into the phone and the system generates a call to an emergency assist system.

Additional features include a “snooze” feature, where a system offers a “snooze” option such that the notification reminder is delivered again at a later time. For example, if a user receives a call on a cell phone to take prescribed medication and is driving, and, thus, cannot comply with the reminder at that time, the user may press the number “2” on the cell phone, thereby “snoozing” the notification call to be made 2 minutes later in the hopes that the user will be able to take the medication at the later time. The user may also select the number of times a notification may be “snoozed” before the system considers the reminder delivery to be a failed attempt and/or a back-up contact from the user's personal network may be notified.

In step 310, the user enters the text of the reminder message. The user may enter this information in a number of manners. For example, the user may simply enter that 4 “pills” are to be taken at certain times throughout a 24-hour period, where a “pill” could mean any type of medication. An alternate embodiment includes the system accessing a medical database and providing a list of medications to be selected by the user. Additionally, the system may store standard prescription instructions associated with specific medications, such that when the user selects a medication from a list, the system automatically generates a schedule of notification reminders based on instructions typically associated with the specific medication. The user may confirm that the system-generated schedule matches the regimen given by the medical provider. Thus, if a user selects a specific heart medication and optionally, a number of pills provided, the system may generate a schedule of notification reminders to be provided four times within a 24-hour period for thirty days, in lieu of the user entering any regimen information. If the instructions prescribed to the user differ from the instructions typically associated with the specific heart medication, the user may modify the reminder as needed. The system also may automatically generate a notification reminder for prescriptions to be refilled.

In addition, the user may select preparation instructions to be included in the notification reminder, such as, for example, “Be sure to take this medication on an empty stomach,” or “Ingestion of this medication may cause drowsiness.” Caution is advised.” If the user has selected for the notification reminders to be sent to back-up contacts from the user's personal network, the same instructions may accompany the notification reminder to the back-up contact. The user may also select educational instructions to be included in the notification reminder, such as, for example, “Matching insulin to food can help you manage your blood sugar more easily” or “Osteoporosis, or porous bone, is a disease characterized by low bone mass and structural deterioration of bone tissue, leading to bone fragility and an increased susceptibility to fractures, especially of the hip, spine and wrist, although any bone can be affected.”

At any time, the user may modify the notification reminder schedule during and after the generation process, as noted in step 312. The user may, for example, change the times of day the notification reminders are to be delivered, the destination(s) of the reminder, an applicable time zone(s) for the notification reminders, specifically if the notification reminders are to be sent to contacts from the user's personal network, and the like.

In step 314, the user may instruct the system to synchronize the notification reminder schedule with a third party application, such as, for example, Microsoft Outlook. This feature allows the user to incorporate a personalized notification reminder outside the system application.

The system may generate and may store a history log of each notification reminder sent each and every delivery attempt for the reminder, and whether each notification reminder was received. The user may view the history log at any time. Additionally, each account may be temporarily suspended when an intended recipient of the notifications is unable to receive the notifications for an extended period of time, such as during a hospital stay, a vacation, and the like.

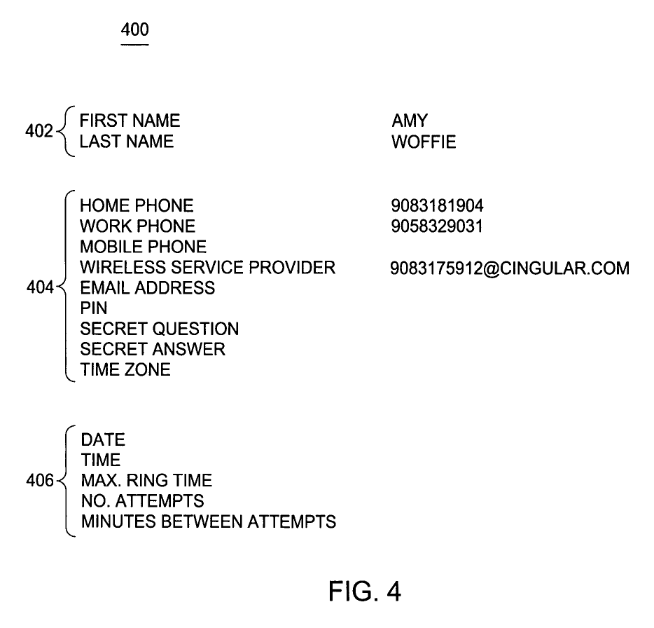

FIG. 4 illustrates a user profile created by a web-based and telephony-based system for creating automated notification reminders. Profile 400 includes the name of the user at 402, and contact information for the user, such as home and business telephone numbers, a contact for text messaging, the user's email address, Personal Identification Number (PIN), a secret question and answer, time zone of the user, and the cellular service provider of the user's cell number, at 404. The system may not automatically begin delivering notification reminders to the user until the user accepts the system invitation. The user at step 406 may select the timing for receiving the system invitation (permission call and email), such as date, time, maximum ring time, number of attempts, and minutes between attempts.

As shown in FIG. 5, a system template 500 for generating a notification reminder includes a plurality of the features described herein. The template 500 may comprise a notification reminder type 502, where the user may select an appropriate notification reminder name, such as, medication, health metrics, doctor's appointment, business meeting, anniversary, and the like.

In section 508, the user may select an appropriate message to accompany the notification reminder type 502 from either a drop list 508a provided by the system, or the user may create a custom message in window 508b. The user may enter a tracking label in section 510 for the notification reminder type 502 for the purpose of finding a specific notification reminder in a list of notification reminders types 502. At 512 the user may temporarily suspend the notification reminder when the intended recipient of the notification reminder(s) is unable to receive the notification reminder(s) for a period of time, such as during a hospital stay, a vacation, and the like.

In the set-up reminder schedule 520, the user enters timing and specifics related to the reminder, such as, start date 522A, frequency 522B, duration of the reminder 522C, end date for the reminder 522D, reminder time 522E, maximum ring times 522F, number of attempts 522G, time between attempts 522H, time zone 522I, snoozing option 522J, and the like. Alternately, the system may automatically generate and/or detect any of such information.

For example, the user may enter a number of seconds the system should allow a phone to ring when attempting delivery of a notification reminder and/or the user may select a number of delivery attempts to be made within a given time period for a notification reminder before the system either moves on to the next delivery mode, or, if no delivery modes remain, logs the delivery as failed. For example, the user may select to be reminded three times within a 24-hour period and the time period to lapse between attempts, such as, ten minutes between each of the three attempts. In one embodiment, the system may register an answering machine pick-up or voicemail pick-up of the notification attempt as a failed attempt.

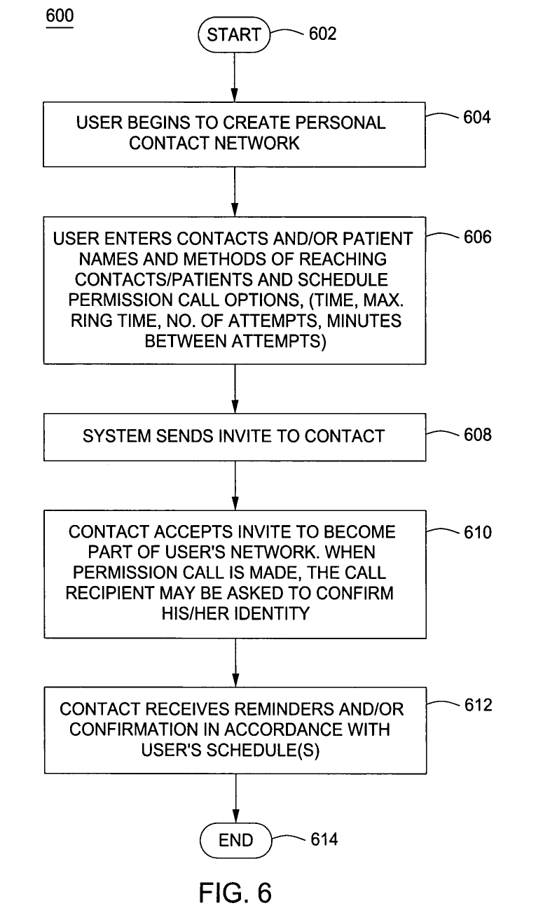

In section 506, the user may enter one or more contact and/or conformation contacts to receiver the reminder. For example, in section 506A, the user may select an order of delivery contacts and one or more modes for each reminder notification. The user may choose from a drop-down list of network contacts previously entered by the user, add new contacts, and enter data associated with the one or more modes of delivery for each contact, which is shown in FIG. 6.

In one embodiment, the user may manage the health of multiple patients, the user can select a contact from a filtered list of contacts for a selected patient. In addition, the user may choose for the system to contact a network contact using, as an example, a home telephone number first, and a cellular number second, an email message third, and a text message fourth. The various modes may be prioritized according to preference. In yet another embodiment, the user may choose alternate network contacts to receive the notification reminder when the previous delivery mode(s) fail.

In section 506B, the user may select one or more confirmation network contacts to receive a confirmation notification of the final disposition of all attempts to deliver the notification reminder. A confirmation contact is a network contact chosen to receive a notification as to whether delivery of the notification reminder was successful. If the user desires confirmation of each notification reminder sent by the system, the user may select the confirmation option appropriate choices, such as, Always, Not Received, Complied, Not Complied. Further, the user, when given authorization, may view notification reminder schedules associated with contacts from the user's personal network.

In one embodiment, the template 500 may include contact and/or confirmation contact agreement information, and the like, as shown in section 518. Finally, the user may submit the reminder by pressing the button 512 or cancel the reminder by pressing the button 514.

FIG. 6 is a flow diagram of a method 600 representing user steps taken to create a personal contact network within a web-based and telephony-based system for creating automated notifications. The steps need not be in the sequence illustrated, and some of the steps may be essentially simultaneous.

The process 600 begins at step 602 and at step 604 the user chooses features offered by the system to create a personal contact network. Such contacts may be selected to receive notification reminders from the user's notification schedule, such as a father may select for his daughter, or a caregiver may select a patient, to be a network contact to receive certain notification reminders. Alternately, a user may choose for the user's network contacts to be confirmation contacts when delivery of notification reminders to the user fails or the user does not comply with the notification reminder, and/or for the contacts to receive notifications by the system that the user confirmed receipt or the user complied with, or did not comply with a specific notification reminder. Additionally, a network contact may comprise a group of network contacts, such as, for example, “Family.”

At step 606, the user may enter the contact name, method of reaching the contacts, and schedule permission call options. For example, the user may enter associated contacts, delivery information, phone numbers, e-mail addresses, time zone for this contact, and/or the schedule for sending out the invitation (date, time, maximum ring time, maximum number of attempts, and minutes between attempts, and the like). Upon receiving the network contact information, the system generates an invitation to each network contact at step 608.

The system requires for each network contact to accept becoming a part of the user's personal network, that is, the system does not automatically begin delivering notification reminders to each network contact until each contact accepts the system invite at step 610. The contact may be asked to confirm his/her identity. Once the network contact agrees to be in the user's personal network, the network contact then may receive notification reminders and/or confirmation notifications at step 612 in accordance with the user's notification reminder schedule(s).

The process ends at step 614 when the user has completed creating the user's personal contact network. The user may authorize the network contacts to view and modify the user's notification reminder schedule(s), and each network contact may create his or her own personal notification reminder schedule(s). However, contacts within a user's personal network may not access schedules associated with other members of the user's personal network without authorization from the other members. For example, a father who has generated a notification reminder schedule may have his son and daughter as members of his personal contact list. The daughter may also have a personal notification reminder schedule and may have access to view and modify her father's reminder schedules. However, without express authorization from the daughter, the son may not access the daughter's reminder schedules by virtue of being a member of the father's personal network.

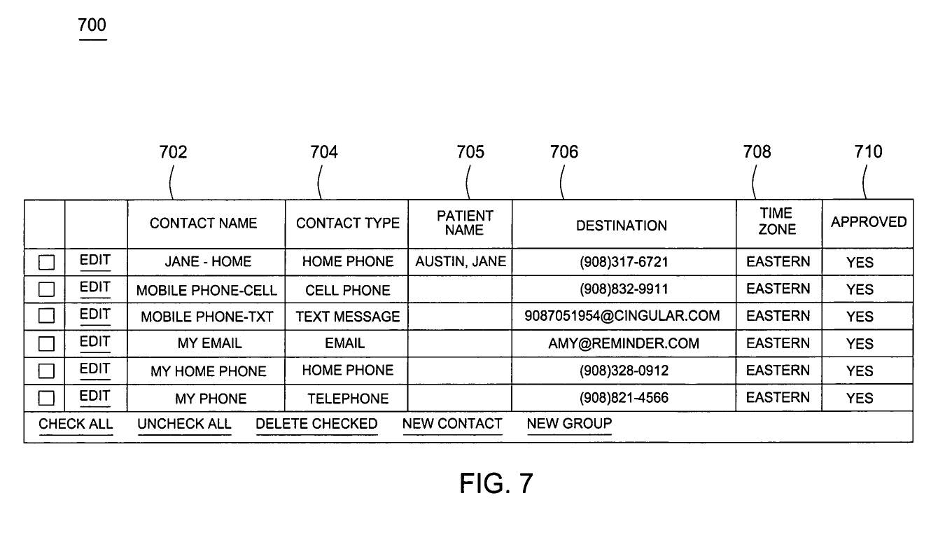

FIG. 7 illustrates a personal network list associated with a user of a web-based and telephony-based system for creating automated notifications. As shown, a contact name at 702 is associated with each network contact as is a mode or connection type 704. The user may be managing the health of multiple patients, and the name of the patient to whom this user is assigned may be displayed at 705. A destination associated with the connection type 704 is displayed at 706 and may include a phone number, email address, text message, and the like. The system may automatically generate a time zone 708 associated with each network contact or the user may enter this information. At 710, the system confirms whether each network contact has agreed to join the user's network and receive notification reminders in accordance with the user's notification reminder schedule(s). In addition, a group of contacts may be created such that a single reminder may be sent automatically to more than one person on the personal network list. When creating Groups, the user may be asked to provide a group name and may be given the opportunity to select among their contacts which ones are to be included in the group.

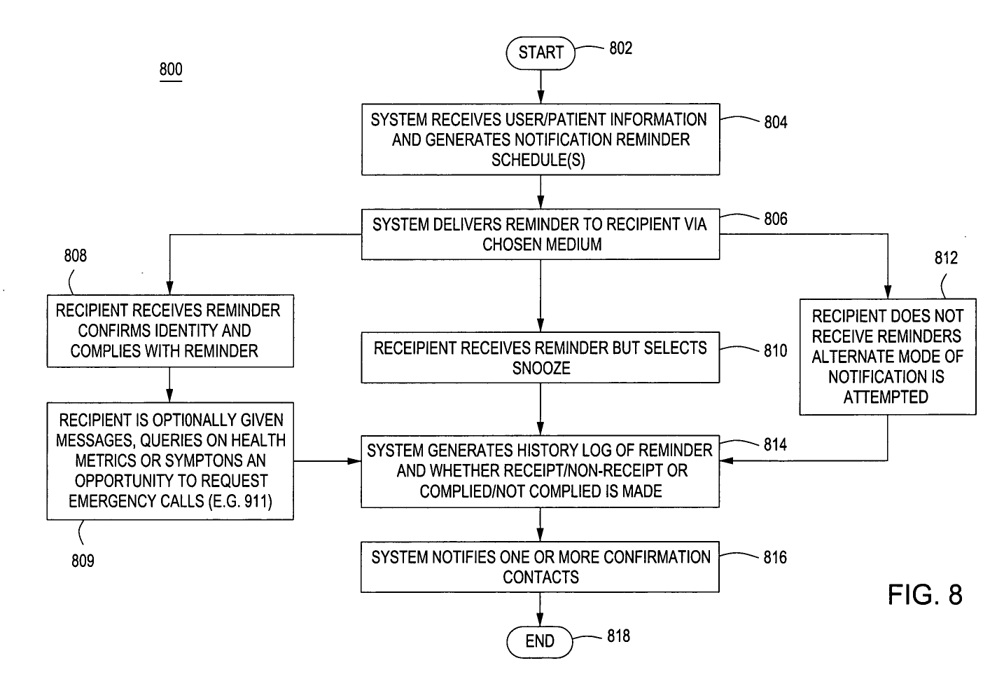

FIG. 8 depicts a flow diagram of an embodiment of a method 800 for providing automated notifications, such as for prescribed medications, using a web-based and telephony-based system. Again, the steps need not be in the sequence illustrated, and some of the steps may be essentially simultaneous.

Starting at step 802, a system receives information entered by a user and one or more notification reminder schedules at step 804, similar to the embodiments described in FIGS. 2 and 3. Once the system generates the notification reminder schedules and the user modifies the schedules (if needed), the system delivers the first notification to the user or designated network contact via the selected medium(s) set in the notification reminder schedule, in step 806. For example, depending on the settings previously chosen by the user, the system allows for a phone to ring a predetermined number of times. Alternately, the system may provide a notification via email and request confirmation of receipt of the email by the designated recipient within a predetermined time period. In another embodiment, the system may provide a notification to a designated recipient using a delivery sequence that includes a telephone call to a residence, a business, and/or a cellular phone, and e-mail, and a text message to a text messaging device.

At step 808, in the instance where the first contact receives the telephone call, the system may request the designated recipient to confirm identification by entering a user's identification and/or a PIN, either verbally or by depressing phone keys. If entered verbally, the system creates and stores an audio file of the verbal identification and associates the file with a history log related to the user's account. The audio file is kept for security purposes and may be accessed by the user to confirm identity of the designated recipient of the notification reminder. The system then verifies the entered information and, if verification is successful, delivers the specific notification reminder and any additional information as previously instructed by the user during the set up of the reminder schedule. The recipient also may confirm acceptance of the message via a verbal entry or by depressing a phone key. Additionally, in accordance with the notification reminder schedule, the system may notify other network contacts of the receipt of the notification by the designated recipient. At step 809, when the recipient confirms acceptance of the message, the recipient may also request regimen instructions, educational messages, or help. Help may be, but is not limited to, emergency service (911) or a family member or a medical provider. In addition, the recipient may be asked to enter a health metric, such as, for example, weight, and the system may check that weight against the data file for the recipient and may generate an “out-of-range” alert to a family member, care giver, case manager or medical provider. Also, when the recipient confirms acceptance of the message, the recipient may be asked to answer some questions. These questions may or may not be patient-specific or generic.

At step 814, the system generates a history log and stores any and all of the following information: that a notification reminder was made at a specific time on a specific date, the reminder notification was received/not received, or complied/not complied with, the specific notification that was delivered, and any additional information, such as whether other network contacts were notified, which network contacts were notified, and/or whether network contacts received confirmation that the designated recipient confirmed receipt/not receipt of or complied/not complied with the notification reminder.

Alternately, the designated recipient may select to delay delivery and receipt of the notification reminder to a later time in step 810 by selecting a “snooze” option, as discussed herein. In step 814, the system may add an entry of the each snoozed event to the history log.

In the instance that the designated recipient does not receive the notification reminder sent in step 806, the system, in step 812, attempts alternate modes of delivering the notification reminder in accordance with the notification reminder schedule, such as additional telephone numbers for the designated recipient, an email message, and the like. The system logs this series of events in the history log in step 814.

In step 816, the system may deliver a confirmation notification to other contacts associated with the user's personal network. For example, the system may alert a designated confirmation contact of the failed receipt/or noncompliance with the notification reminder by the designated recipient, in accordance with the notification reminder schedule. Alternately, the system may send a confirmation notification to a confirmation contact that the intended recipient confirmed receipt of/complied with the notification reminder. The process ends at step 818 once the system has performed all steps to deliver a notification reminder in accordance with the user's notification reminder schedule.

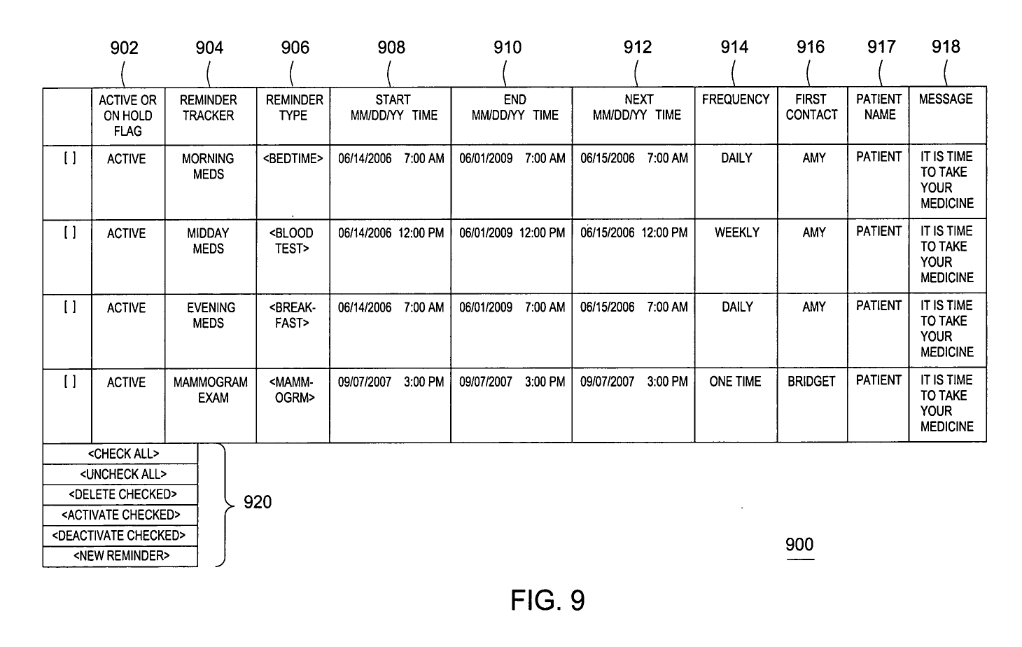

FIG. 9 depicts an embodiment of a notification reminder schedule generated by a web-based and telephony-based automated notification system. This notification schedule is combined in that there are different types of notification reminders contained within one notification schedule, such as medication regimen notifications, medical appointments, and the like. A user may access the portion 900 using a computer and it may include an active/on hold selection 902 where a user may temporarily suspend a notification reminder from being delivered, one or more notification reminder names 904, such as “Morning Meds” for example, and a type 906 of reminder, such as “Breakfast” for example. In another embodiment, a user may have individual notification reminder schedules for each notification reminder type, for example, a notification schedule related to medical regimens only, a second notification schedule for social reminders, and the like.

The start date for each notification reminder is provided at 908 and includes a month, day, year, and time of day the notification reminder is to occur. An end date associated with each notification reminder is shown at 910 and is similar to the start date 908. At 912, the schedule displays a next occurrence of each notification reminder. The system automatically updates this column when delivery of the notification is completed.

The frequency associated with each notification reminder, such as “Daily,” “Weekly,” or “One Time,” is shown at 914 and a first contact to receive the notification is shown at 916. Optionally, the patient for whom the reminder is scheduled is provided at 917. The notification message previously selected and/or customized by the user is provided at 918. The user may choose the features shown at 920, namely, “Check All,” “Uncheck All,” “Delete Checked,” “Activate Checked,” Deactivate Checked,” and “New Reminder” to modify the notification reminder schedule as needed. Optionally, the user may access the data underlying the notification reminder schedule, such as the data shown in the embodiment described in FIG. 5, by selecting hyperlinks that may be provided within the portion 900 by the system.

Another embodiment may include a history log generated by a web-based and telephony-based automated notification system. The history log may have fields similar to the embodiment described in FIG. 9 and may include an additional field of entries describing the result of each delivery attempt by the system. Such results may include, but are not limited to, “Complied,” “Not Complied,” “In Progress,” “Exhausted” and the like.

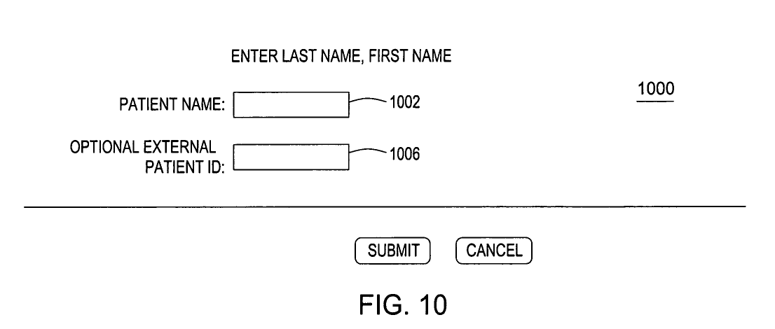

The foregoing embodiment is generally used by individuals that require reminders of their healthcare regimen. However, an alternative embodiment adapts the foregoing embodiment for use by healthcare professionals (e.g., doctors, nurses, case workers and the like) to track compliance of a patient to their healthcare regimen. FIG. 10 depicts a screen 1000 for entering patient information into the system. Once a patient is entered and has given permission, the healthcare professionals may send reminders and obtain statistics regarding compliance. The patient's name (1002) and an optional external identifier (1006) may be recorded.

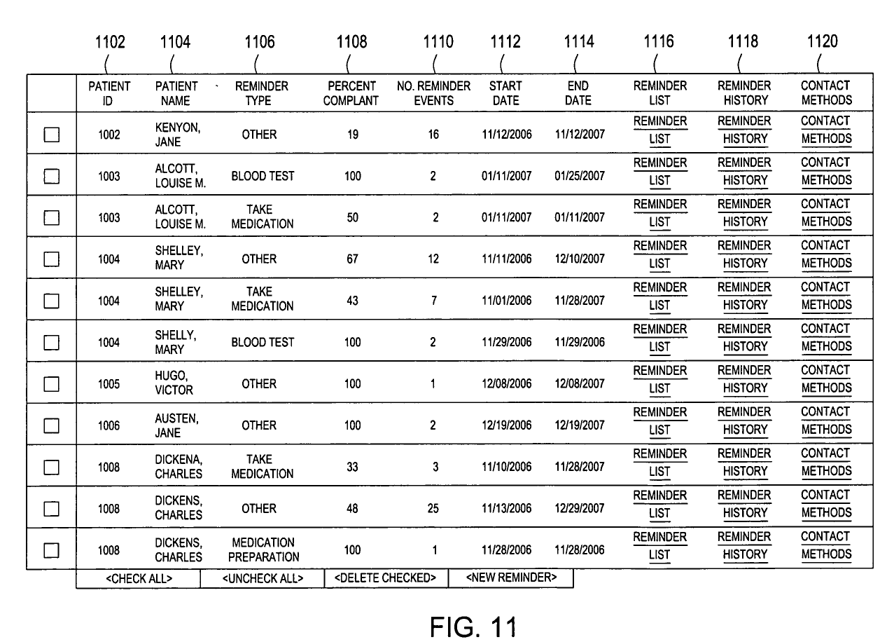

FIG. 11 depicts the embodiment of patient's compliance rates to the reminders provided to them generated by a web-based and telephony-based automated notification system. The patient Identification numbers (IDs) (internal and external) may be reported (1102), as well as the patient's name (1104). The aggregated compliance for all reminders of a given reminder type may be displayed in a bar chart format (1108), based on the number of reminder events that have occurred (1110). The start date (1112), end date (1114), for the given reminder type (1106) may also be displayed. Users can view the subset of reminders that have been scheduled for a patient, i.e. reminder list (1116), as well as, their history (1118) and list of contacts used to reach them (1120).

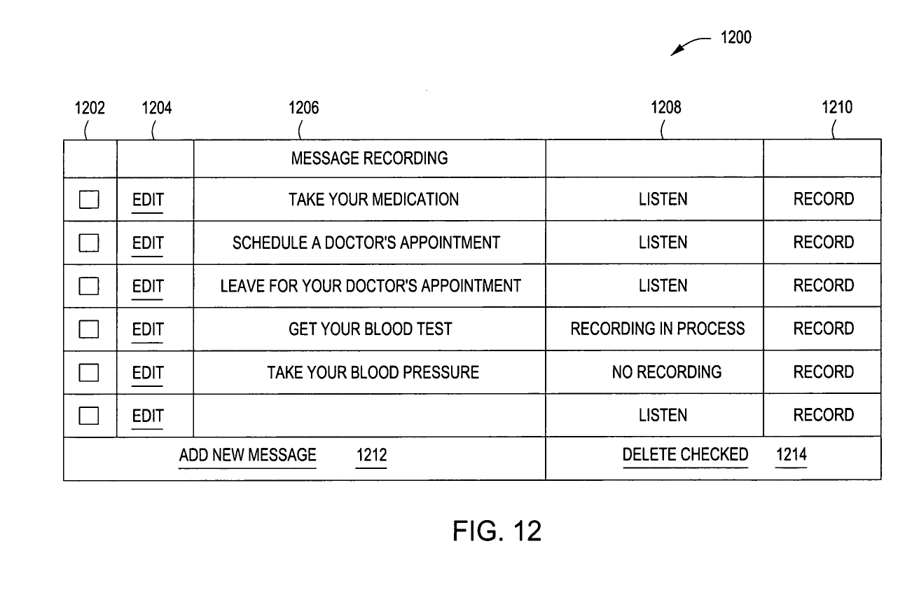

FIG. 12 depicts the embodiment of a screen 1200 used for reviewing message recordings generated by a web-based and telephony-based automated notification system. Messages used in reminders sent by phone may be pre-recorded on the phone or on the web. A list of pre-recorded and non-recorded reminder messages is displayed (1206). Users may edit these messages (1202, 1204), listen to the recordings (1208), and re-record existing recordings (1210), as well as, record new messages (1212) or delete message recordings (1214, 1202).

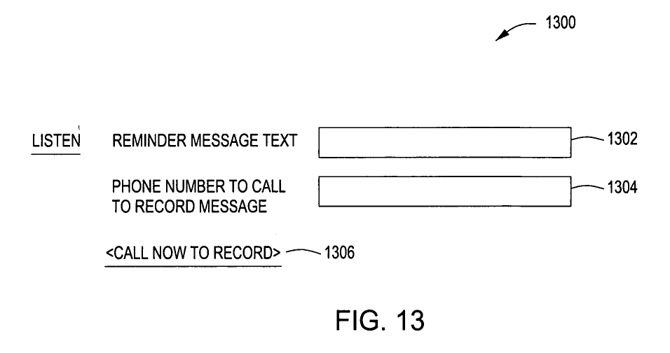

FIG. 13 depicts the embodiment of a screen 1300 used for generating a call to record a notification reminder generated by a web-based and telephony-based automated notification system. The text version of the message is presented and may be modified (1302), and the phone number to call to record the message is entered in 1304. The user clicks on a link (1306) to initiate the phone call to record the notification reminder.

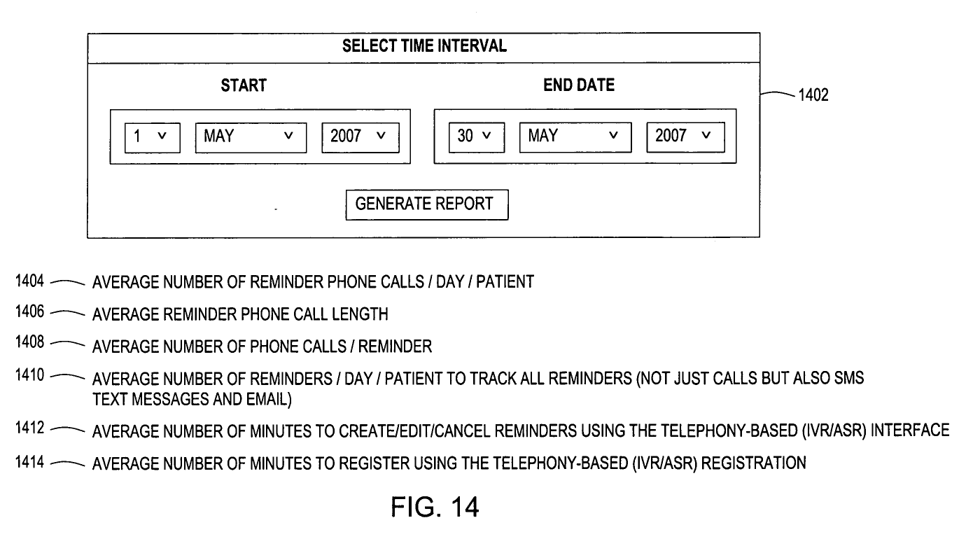

FIG. 14 depicts a screen 1400 through which a user may generate reports to track system usage and resources used, generated by a web-based and telephony-based automated notification system. System administrators may select a time period for the report (1402) and then generate a report detailing the average number of notification reminder phone calls per day per patient (1404); the average notification reminder phone call length [1406]; the average number of phone calls per notification reminder [1408]; the average number of calls, email, text messages and the like notification reminders per day per patient [1410]; the average number of minutes to create, edit or cancel notification reminders using the telephony-based interface (1412); and the average number of minutes used to register using the telephony-based interface (1414).

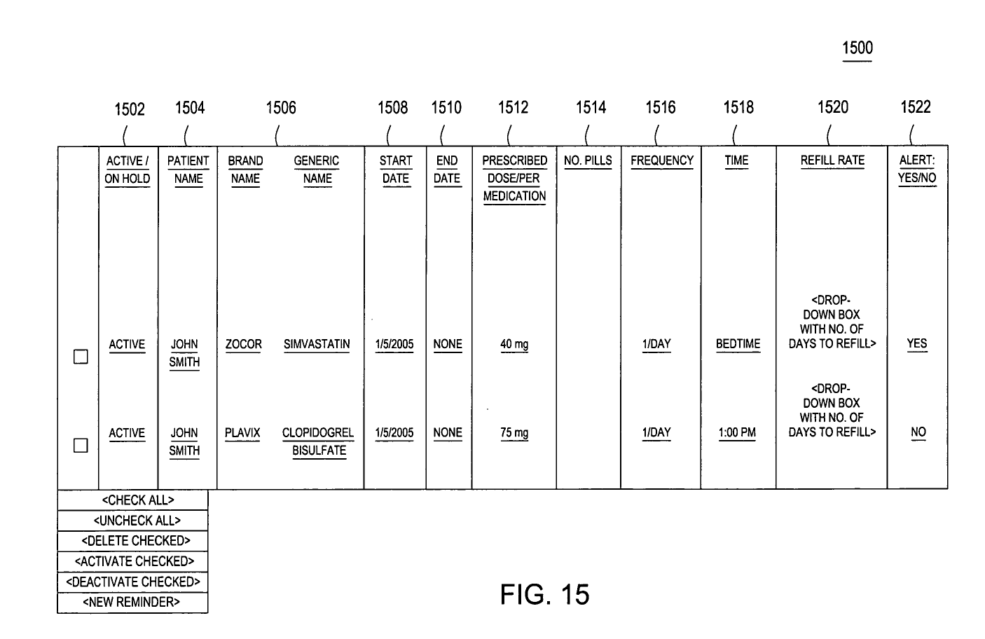

FIG. 15 depicts one embodiment of a screen 1500 used for medication input into a web-based and telephony-based automated notification system. The screen 1500 may include an active/on hold selection (1502) where a user may temporarily suspend a medication. Users may enter their name (1504). The user may enter a brand or generic medication (1506), a start date (1508) and end date (1510), the prescribed dosage requirements (1512), which may include but is not limited to the number of pills to be taken (1514), the frequency the user would take the medication (1516), the time of day each medication should be taken (e.g. breakfast, mid-morning, lunch, mid-afternoon, 1:00 pm, dinner, evening, bedtime (1518), and the like), the refill rate (1520) and the user may request a refill alert when it is time to refill the medication (1522). Alternately, the system may generate dosage requirements (1512), (1514), (1516) and ask for confirmation against those set forth by the prescriber. Or, the system may populate the medications being taken by the user, from a third party, for example, claims data. Optionally, users may request that the system automatically create reminders, based on the regimen instructions, and users may accept, modify or delete the reminders.

While the foregoing is directed to embodiments of the present invention, other and further embodiments of the present invention may be devised without departing from the basic scope thereof.

What is claimed is:

1. A method for providing notification reminders via a communications system, comprising:
generating at least one of a web-based or telephone-based interface to an account supported by a server;
creating, through the at least one of a web-based or telephone-based interface, notification reminder information comprising a notification reminder, contact information for at least one entity to receive the notification reminder; and a mode of receiving the notification reminder.

2. The method of claim 1, wherein the creating step further comprises:
entering, through the at least one of a web-based or telephone-based interface, confirmation information comprising a confirmation, and contact information for at least one confirmation entity to receive the confirmation regarding the notification reminder.

3. The method of claim 2, wherein the at least one entity in the notification reminder information or the confirmation information has authorized their use as a recipient.

4. The method of claim 2, further comprising maintaining a history log of utilization of at least one of the notification reminder information or the confirmation information.

5. The method of claim 2, further comprising editing the at least one of the notification reminder information or the confirmation information using the at least one of the web-based or the telephone-based interface.

6. The method of claim 2, wherein at least one of the notification reminder or confirmation comprises a message, wherein the message is at least one of an educational message, a medically-related reminder message, an instructional message, an emergency message, an appointment, or an occasion.

7. The method of claim 6, wherein the message is at least one of a customized message, preexisting optional message, pre-selected message, pre-recorded message or a modified pre-selected message.

8. The method of claim 2, further comprising transmitting a communication, where the communication contents and delivery is defined by at least one of the notification reminder information or the confirmation information.

9. The method of claim 8, further comprising verifying at least one of the receipt of the transmission of a confirmation or compliance of a recipient with a notification reminder.

10. The method of claim 8, further comprising transmitting the at least one of the notification reminder or the confirmation to at least one of a wireless device, a landline telephone, an audio device, a text messaging device or an alarm.

11. The method of claim 8, further comprising transmitting the at least one of the notification reminder or the confirmation to at least two entities.

12. The method of claim 8, further comprising transmitting at least one of the notification reminder or the confirmation in at least two different communication formats.

13. The method of claim 8, further comprising requesting a response from the entity receiving a notification reminder.

14. The method of claim 8, wherein the transmitting step further comprises:
sequencing transmission of at least one of the notification reminder or the confirmation according to at least one of priority, failure, importance, specification, or preference.

15. The method of claim 14, wherein the sequencing step further comprises transmitting at least one of the notification reminder or the confirmation, in a defined order, to a plurality of the entities, where the plurality of entities and the order are defined in at least one of the notification reminder information or the confirmation information.

16. The method of claim 1, wherein the generating step is supported using at least one of a wireless device, a landline telephone, a text messaging device, an audio device, or a key entry device.

17. The method of claim 1, wherein the notification reminder information comprises contact information for an entity to be contacted regarding a final disposition of the notification reminder.

18. The method of claim 16, wherein the final disposition comprises at least one of receipt of the notification reminder, non-receipt of the notification reminder, compliance by a notification reminder recipient with the notification reminder, or non-compliance by a notification reminder recipient with the notification reminder.

19. The method of claim 1, wherein the telephone-based interface comprises interactive voice recognition/automated speech recognition.

20. The method of claim 1, wherein the creating step further comprises managing, through the at least one web-based or telephone-based interface, a notification reminder for a plurality of patients.

21. The method of claim 1, wherein the creating step further comprises generating a notification reminder schedule comprising notification reminder information for a plurality of notification reminders.

22. A system for providing a notification reminder, comprising:
at least one of a web-based or telephone-based interface, coupled to a communications network, through which a user creates notification reminder information comprising a notification reminder, contact information for an entity to receive the notification reminder, and a mode of delivery for the notification reminder; and
a server for receiving the notification reminder information from the communications network and delivering the notification reminder in accordance with the notification reminder information.

23. The system of claim 22, wherein the notification reminder is a medically-related reminder, an educational message, an instruction message, an emergency message, an appointment or an occasion.

24. The system of claim 22, wherein the at least one of web-based or telephone-based interface is supported by at least one of a wireless device, a landline telephone, an audio device, or a key entry device.

25. The system of claim 23, wherein the server delivers the notification reminder to at least one of a wireless device, a landline telephone, an audio device, a text messaging device or an alarm.
